(19) United States
(12) Patent Application Publication
(10) Pub. No.: US 2008/0006128 A1
(43) Pub. Date: Jan. 10, 2008

(54) Wrench with H-shaped handle

(76) Inventor: Chih-Ching Hsieh, Taichung City (TW)

Correspondence Address: PHILLIP LIU, 6980, WHITEOAK DR., RICHMOND, BC, V7EAZ9, CA

(21) Appl. No.: 11/480,951

(22) Filed: Jul. 6, 2006

(51) Int. Cl. B25B 13/00; B25B 23/16; B25G 1/00

(52) U.S. Cl. 81/177.1; 81/125.1

(57) ABSTRACT

A wrench includes an H-shaped handle and two function ends on two ends of the handle. The handle includes a recessed area defined in two sides thereof so as to form two flat surfaces on two sides of the recessed area. A width is 3 to 4 times of a thickness of the flat surface. A thickness of each of the two function ends is the same as a thickness of the handle. The wrench is light in weight and the function ends can be easily inserted to a narrow space.

### FIELD OF THE INVENTION

The present invention relates to a wrench with an H-shaped handle and a thickness of the function ends of the wrench is the same as the thickness of the handle.

### BACKGROUND OF THE INVENTION

A conventional wrench 90 is shown in FIG. 7 and generally includes a handle 91 which has an open end 93 and a box end 92 on two ends of the handle 91. The open end 93 and the box end 92 are obviously thinker than the thickness of the handle 91 so that they might not be inserted into a narrow space to reach the object to be tightened or loosened. Besides, the thick handle 91 and the even thicker open end 93 and box end 92 make the wrench to be heavy and costly.

The present invention intends to provide a wrench that has an H-shaped handle and two function ends which have the same thickness as the handle so that the wrench is light in weight and can be easily inserted into a narrow space.

### SUMMARY OF THE INVENTION

The present invention relates to a wrench which comprises a handle and an open end is connected to an end of the handle. A recessed area is defined in one of two sides of the handle so as to form two flat surfaces on two sides of the recessed area. A width is 3 to 4 times of a thickness of the flat surface. A thickness of the open end is the same as a thickness of the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wrench of the present invention;

FIG. 2 is a plain view of the wrench of the present invention;

FIG. 3 is a side cross sectional view along A-A line in FIG. 2 of the wrench of the present invention;

FIG. 4 is a cross sectional view to show a cross sectional view of the handle;

FIG. 5 shows that a user holds the handle of the wrench to operate a bolt;

FIG. 6 shows that the open end of the wrench of the present invention is inserted into a narrow space to reach a bolt, and

FIG. 7 shows a conventional wrench.

### DETAILED DESCRIPTION OF THE PREFERRED EMBODIMENT

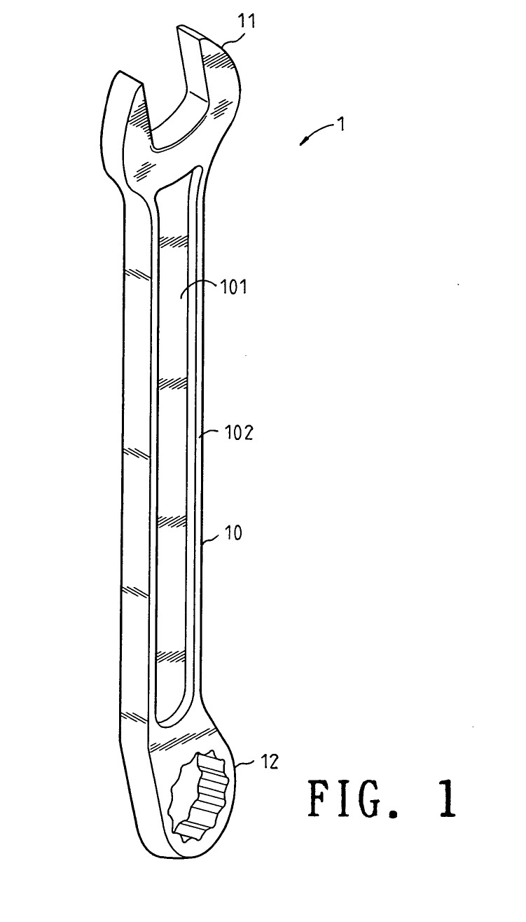

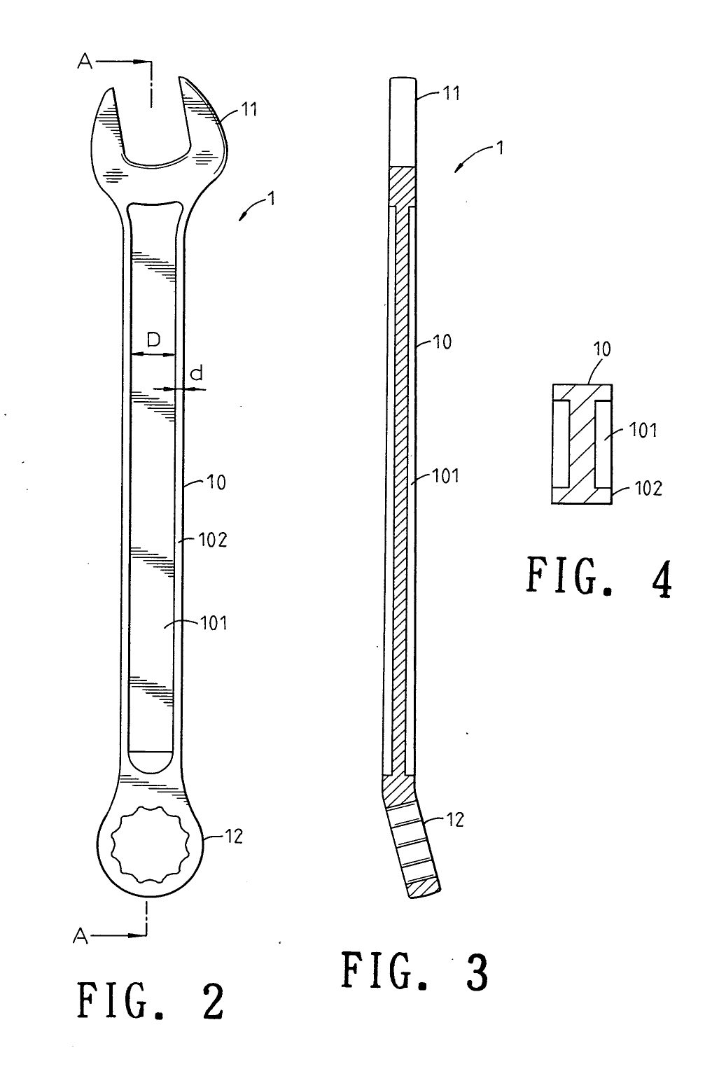

Referring to FIGS. 1 to 4, the wrench 1 of the present invention comprises a handle 10, an open end 11 and a box end 12 are respectively connected to two ends of the handle 10. Two recessed areas 101 are defined in two sides of the handle 10 and each recessed area 101 is defined by two flat surfaces 102 on two sides of the recessed area 101. Each recessed areas 101 is located at a central portion of each side of the handle 10. The handle 10 has an even thickness except for the recessed areas 101. A width “D” is 3 to 4 times of a width “d” of the flat surface 102. A thickness of each of the recessed areas 101 is a quarter of a thickness of the handle 10. A thickness of the open end 11 and the box end 12 is the same as a thickness of the handle 10. The box end 12 extends an angle, such as 15 degrees, relative to a longitudinal axis of the handle 10.

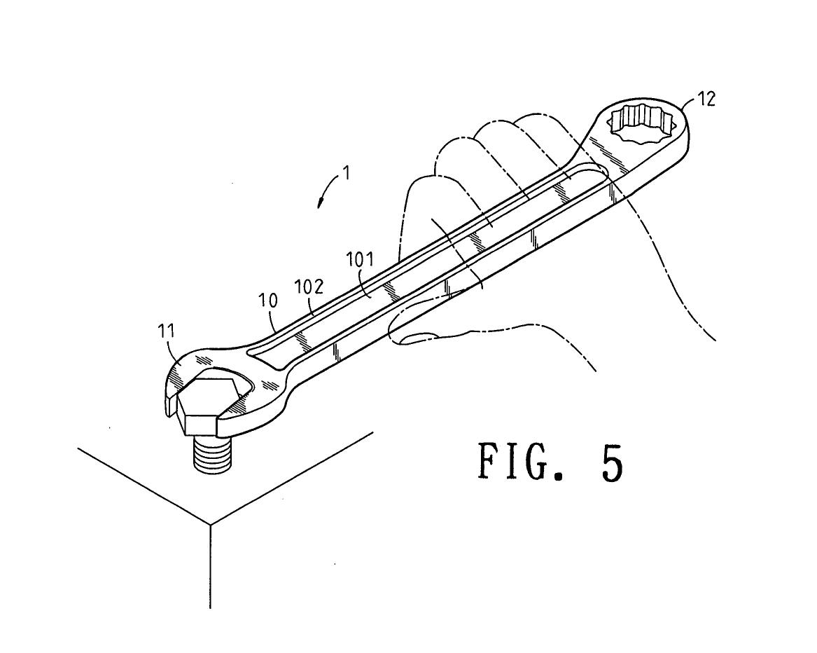

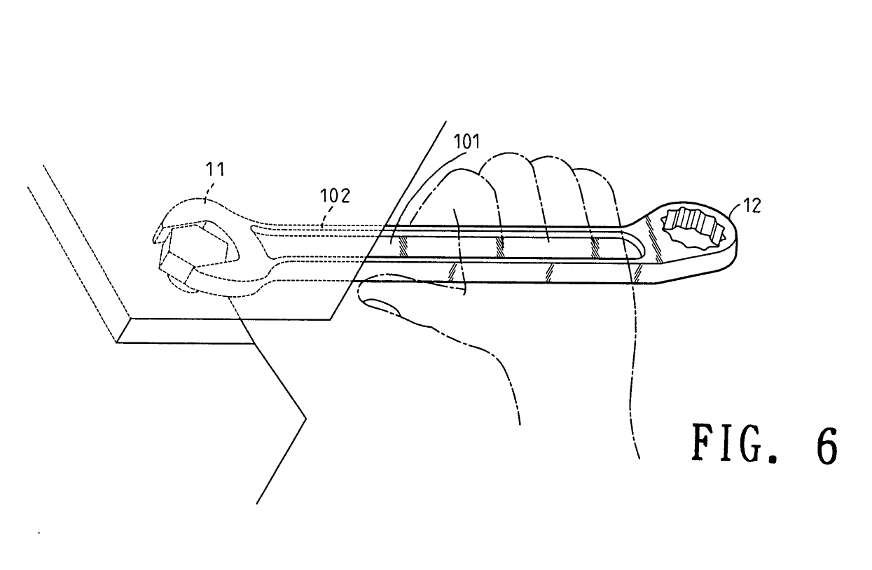

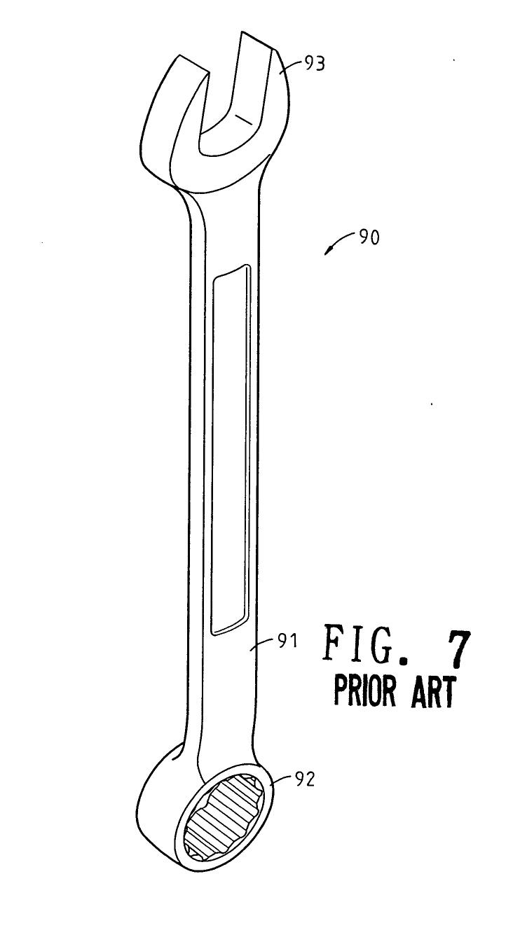

As shown in FIGS. 5 and 6, the wrench 1 is light in weight because of the recessed areas 101 in the two sides of the handle 10. Besides, because the open end 11 and the box end 12 of the handle 10 have the same thickness as the handle 10, the open end 11 or the box end 12 can be easily inserted into a narrow space to reach the bolt as shown in FIG. 6.

The handle 10 of the wrench 1 of the present invention is strong enough to bear torque when the user applies torque to the bolt whole the recessed recesses areas 101 make the wrench to be light in weight and use less material.

While we have shown and described the embodiment in accordance with the present invention, it should be clear to those skilled in the art that further embodiments may be made without departing from the scope of the present invention.

1. A wrench comprising:
a handle and an open end connected to an end of the handle, a recessed area defined in one of two sides of the handle so as to form two flat surfaces on two sides of the recessed area, a width being 3 to 4 times of a width of the flat surface, a thickness of the recessed area being a quarter of a thickness of the handle, a thickness of the open end being the same as a thickness of the handle.

2. The wrench as claimed in claim 1, wherein a box end is connected to the other end of the handle.

3. The wrench as claimed in claim 1, wherein the recessed area is located at a central portion of the handle.

4. The wrench as claimed in claim 1, the handle has an even thickness except for the recessed area.

5. The wrench as claimed in claim 2, wherein the box end extends an angle relative to a longitudinal axis of the handle.

6. (canceled)
